(19) United States
(12) Patent Application Publication
(10) Pub. No.: US 2006/0230713 A1
(43) Pub. Date: Oct. 19, 2006

(54) Wet type air cleaner

(75) Inventor: Woong Kim, Seoul (KR)

Correspondence Address: BACON & THOMAS, PLLC, 625 SLATERS LANE, FOURTH FLOOR, ALEXANDRIA, VA, 22314, US

(73) Assignee: DAEWOO ELECTRONICS Corporation, Seoul (KR)

(21) Appl. No.: 11/268,490

(22) Filed: Nov. 8, 2005

(30) Foreign Application Priority Data
Apr. 5, 2005 (KR) 10-2005-0037446

(51) Int. Cl. B01D 46/00

(52) U.S. Cl. 55/283

(57) ABSTRACT

A wet type air cleaner includes a housing containing a water in a bottom thereof; a blower unit installed in an upper portion of the housing and having a blower for generating a suction air flow to send air to the water, the blower being driven by a single driving source; a water spray unit for drawing up and dispersing the water; and a guide unit located between the water spray unit and the water, for guiding the water from the water spray unit to redisperse the water. The blowing operation of the blower unit and the water intake of the water spray unit are achieved by the single driving source.

### FIELD OF THE INVENTION

The present invention relates to a wet type air cleaner; and, more particularly, to a wet type air cleaner having a negative ion generating function, capable of improving air purifying efficiency by maximizing a contact area between cleaning water and exterior air by way of dispersing the cleaning water multiple times.

### BACKGROUND OF THE INVENTION

In general, an air cleaner serves to purify indoor air containing fine dusts, various noxious gases, various germs, molds, viruses, etc., by using a purification medium. Such an air cleaner can be used through all seasons because it has various functions of removing unpleasant odors and small particles such as ticks, pollen and furs of pets, preventing an outbreak of disease due to an aerial infection, and so forth as well as its principal function of maintaining indoor air clean and pleasant.

Air cleaners can be largely classified into two types: dry type and wet type. Dry type air cleaners can be divided again into a filter type and an electric dust collection type.

Here, the electric dust collection type uses no filter, so it has a merit in that there is no need to replace filters. However, if dusts are accumulated on an electric dust collecting plate, purifying efficiency of the air cleaner will be deteriorated, and dust removing capacity thereof will also be undermined.

As for the filter type air cleaner, on the other hand, since various fine particles are captured while air passes through filters, the filter type air cleaner exhibits a high purifying efficiency, and thus is adequate for use in a season when yellow dust comes. However, since the filters need to be exchanged periodically, maintenance cost thereof is high.

Meanwhile, a wet type air cleaner employs a method for making floating particles in suctioned air deposited in water by allowing the suctioned air to contact with water. Though the wet type air cleaner has not been commonly utilized yet, it has many advantages in that it does not requires an exchange of filters and generates little noise, while providing a humidifying function as well. Thus, for children, its use is preferred. However, when using the wet type air cleaner, water should be renewed or replenished, which would be rather cumbersome.

One of such wet type air cleaners is disclosed in Japanese Patent Laid-open Publication No. 2000-334240, entitled “WET TYPE AIR CLEANER”.

The wet type air cleaner includes an air circulation passage through which air is introduced into the inside of the air cleaner and then is outputted to the outside after being purified. A reservoir containing therein liquid to be sprayed is formed in a part of the air circulation passage. The air cleaner further includes a blower unit for allowing the air to be circulated through the air circulation passage and a spray unit for spraying the liquid into a spray space in the reservoir.

The blower unit includes a blower for suctioning the air into the spray space and a motor for driving the blower. The spray unit includes a pump for pumping up the liquid from the reservoir and a nozzle for spraying the liquid into the spray space therethrough.

Further, the air supplied into the air circulation passage typically flows downward after being introduced into the reservoir from upside, whereas the liquid is sprayed upward from downside. Therefore, the air introduced into the reservoir is brought into contact with fine liquid particles sprayed by the nozzle, thereby allowing noxious substances in the air to be adsorbed by the liquid.

In the conventional wet type air cleaner as described above, however, the blower unit for circulating the indoor air and the spray unit for spraying the liquid are installed individually. Therefore, the number of components of the air cleaner cannot be reduced below a certain level.

Besides, in the conventional wet type air cleaner, droplets adsorbing fine dust are discharged outside together with the air, thereby resulting in a poor purification efficiency and an unexpected high humidity. Moreover, the contact between the cleaning water and the air is insufficient, so that the purification ability thereof is deteriorated.

### SUMMARY OF THE INVENTION

It is, therefore, a first object of the present invention to provide a wet type air cleaner with a negative ion generating function, capable of maximizing a negative ion generating effect as well as improving air purifying efficiency by way of increasing a contact area between water particles and air, and, also, capable of reducing component costs by achieving a water intake and a blower operation by means of a single driving source.

It is a second object of the present invention to provide a wet type air cleaner with a negative ion generating function, capable of preventing water drops containing therein dust particles from being discharged outside the air cleaner along with a purified air flow, thus preventing a deterioration in air cleaning efficiency and an increase of humidity of exterior air over a preset level.

It is a third object of the present invention to provide a wet type air cleaner with a negative ion generating function, capable of preventing an increase of noise as a result of jetting water to a wall of the air cleaner for the purpose of adsorbing dusts or the like contained in the air by the water.

It is a fourth object of the present invention to provide a wet type air cleaner with a negative ion generating function, capable of improving air purifying efficiency greatly by maximizing a contact area between cleaning water and exterior air by way of dispersing the cleaning water multiple times.

In accordance with the present invention, there is provided a wet type air cleaner including: a housing containing a water in a bottom thereof; a blower unit installed in an upper portion of the housing and having a blower for generating a suction air flow to send air to the water, the blower being driven by a single driving source; a water spray unit for drawing up and dispersing the water; and a guide unit located between the water spray unit and the water, for guiding the water from the water spray unit to redisperse the water, wherein the blowing operation of the blower unit and the water intake of the water spray unit are achieved by the single driving source.

### BRIEF DESCRIPTION OF THE DRAWINGS

The above and other objects and features of the present invention will become apparent from the following description of preferred embodiments, given in conjunction with the accompanying drawings, in which:

FIG. 1 shows a cross sectional view of a wet type air cleaner having an negative ion generating function in accordance with the present invention; and

FIG. 2 illustrates a perspective view of major components thereof.

### DETAILED DESCRIPTION OF THE PREFERRED EMBODIMENTS

Hereinafter, a wet type air cleaner having a negative ion generating function in accordance with a preferred embodiment of the present invention will be described in detail with reference to the accompanying drawings.

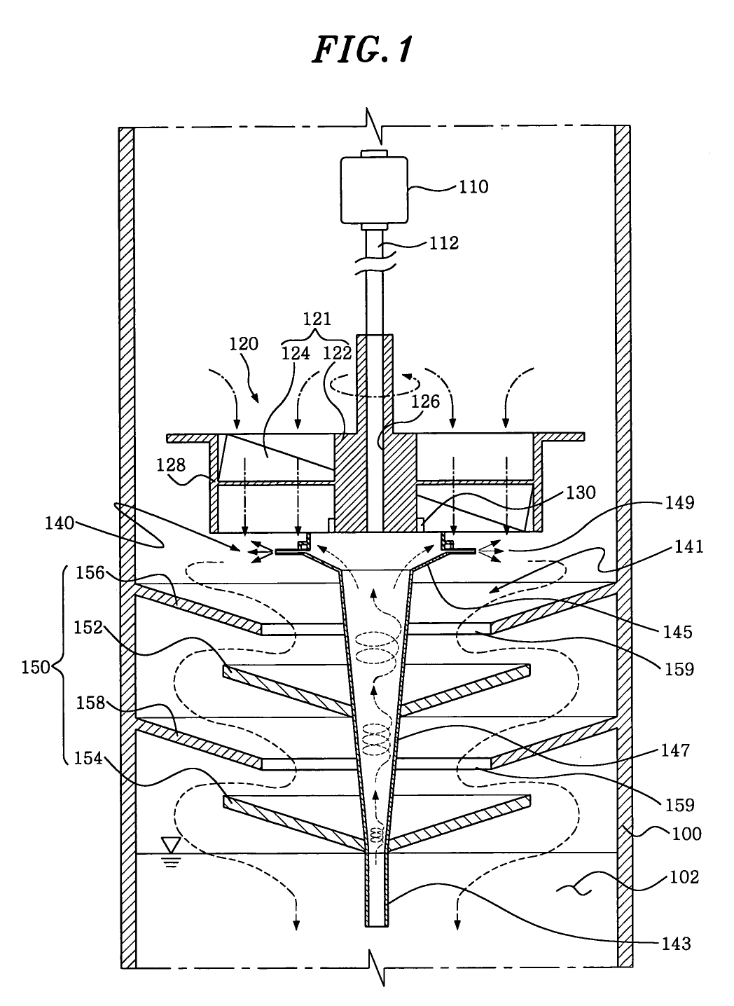

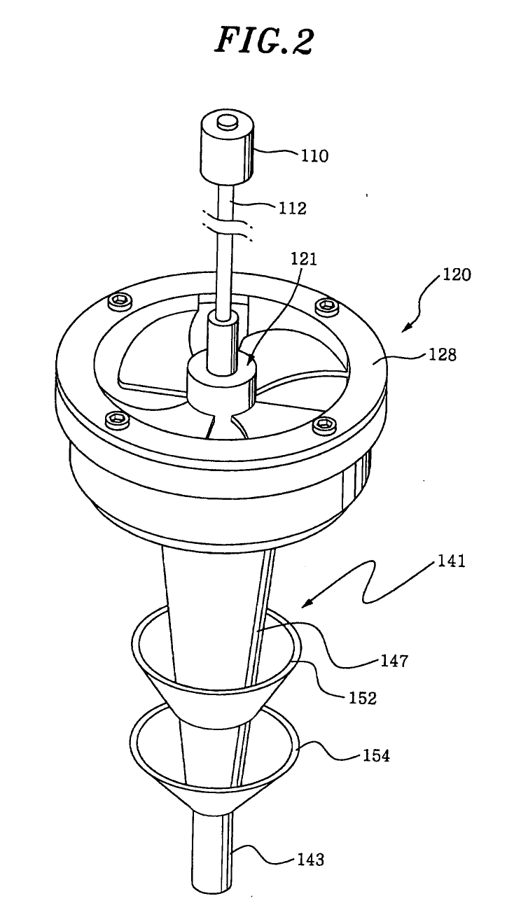

FIG. 1 shows a cross sectional view of a wet type air cleaner having an negative ion generating function in accordance with the present invention; and FIG. 2 illustrates a perspective view of major components thereof.

The wet type air cleaner includes a housing 100; a driving unit 110 serving as a driving source and installed in the housing 100; and a blower unit 120 provided in the housing 100, for generating a suction air flow to suction indoor air into the housing 100.

The housing 100 contains, e.g., a cleaning water 102 in a bottom thereof and is provided with an air inlet(not shown) for introducing the indoor air into the housing 100 therethrough and an air outlet(not shown) for discharging a purified air into an indoor space therethrough. The driving unit 110 has a rotating shaft 112 vertically installed in the housing 100 and connected to the blower unit 120, for transfering a driving force of the driving unit 110 to the blower unit 120. The blower unit 120 has a blower 121 for generating a suction force and a casing 128 for accommodating the blower 121. The blower 121 has a blower main body 122 whose periphery is radially provided with a plurality of blades 124 for moving the indoor air. The blower main body 122 is provided with a central hole 126. The blower 121 is connected to the rotating shaft 112 by being tightly fitted around the rotating shaft 112 through the central hole 126 to rotate together with the rotating shaft 112.

The wet type air conditioner further includes a water spray unit 140 connected to the blower main body 122 by, e.g., an engagement 130, for spraying the cleaning water 102 and a guide unit 150 for guiding the cleaning water 102 sprayed from the water spray unit 140 to redisperse the water.

The water spray unit 140 has a water intake unit 141 for drawing up the cleaning water 102 and one or more, e.g., two spray nozzles 149 for spraying the cleaning water 102 drawn by the water intake unit 141. The water intake unit 141 is formed of a funnel-shaped pipe whose cross section is narrowed from top to bottom. The water intake unit 141 has a lower end portion 143 submerged in the cleaning water 102, an upper end portion 145 provided with the spray nozzles 149, and a middle portion 147 located between the lower end portion 143 and the upper end portion 145.

The lower end portion 143 of the water intake unit 141 serves as a cleaning water inlet portion through which the cleaning water 102 contained in the housing 100 is introduced into the water intake unit 141. In order to facilitate the water intake, the middle portion 147 and the upper end portion 145 of the water intake unit 141 are so formed that their diameters become greater as moving to the bottom surface of the casing 128, the average diameter of the middle portion 147 being greater than that of the upper end portion 145. The water spray nozzles 149 are provided at the periphery of the upper end portion 145 of the water intake unit 141 to communicate with the interior of the housing 100.

The guide unit 150 located between the water spray unit 140 and the cleaning water 102 has one or more, e.g., an upper and a lower first guide members 152, 154 installed at the water intake unit 141 of the water spray unit 140 and one or more, e.g., an upper and a lower second guide member 156, 158 provided at the housing 100. The first guide members 152, 154 are outwardly, upwardly extended from the lateral surface of the middle portion 147 of the water intake unit 141 by a predetermined distance to have a ring shape and the second guide members 156, 158 are inwardly, downwardly extended from the inner wall of the housing 100 by a preset distance to form openings 159 for passing the cleaning water 102 therethrough. The openings 159 have a diameter equal to or smaller than a maximum diameter of the first guide members 152, 154.

Besides, the first guide members and the second guide members 156, 158 are arranged alternately while being distanced away from each other. Specifically, the upper second guide member 156, the upper first guide member 152, the lower second guide member 158 and the lower first guide member 154 are installed in this order from the top down.

As mentioned above, since the openings 159 have a smaller diameter than a maximum diameter of the first guide members 152, 154, the water 102 flowing along the inner wall of the housing 100 is prevented from flowing into spaces between the first and the second guide member 152, 154 and 156, 158 when it is guided to the first guide members 152, 154 along the second guide members 156, 158. Therefore, dispersion of the cleaning water 102 can be performed effectively.

In the above configuration, the blower unit 120 and the water spray unit 140 are connected to each other by the engagement 130 as one body, so that they can rotates simultaneously by the single driving unit 110.

Although the above discussions refer to a situation where the water spray unit 140 is connected to the blower main body 122 by the engagement 130, the water spray unit 140 and the blower unit 120 can be formed as a single body.

Below, an operation of the wet type air cleaner with the above-described configuration will be described.

First, a rotational force generated by the driving unit 110 is transferred to the blower main body 122 of the blower unit 120 via the rotating shaft 112 which in turn rotates the blades 124 formed as on body therewith as well, thereby suctioning the ambient air to send the air downward below the blower unit 120, i.e., to the water spray unit 140.

At the same time, the water spray unit 140 fixed to the blower unit 120 via the engagement 130 rotates as well which in turn allows the lower end portion 143 of the water intake unit 141 to introduce the cleaning water 102 contained in the housing 100 and draws up the cleaning water 102 via the middle portion 147 and the upper end portion 145 by a centrifugal force.

Then, the cleaning water 102 is moved up to the water spray nozzles 149 to be outwardly dispersed therefrom. When the dispersed water 102 contacts with the air sent downward by the blades 124, bacteria, dusts and the like contained in the air are adsorbed by the dispersed water 102 and gaseous contaminants in the air are also dissolved in the dispersed water 102. As a result, the air can be purified.

In case the cleaning water 102 is finely jetted, a large amount of air containing negative ions is generated due to Renard's Effect. The amount of the negative ions contained in this air is greater than the amount of negative ions generated by a high-pressure discharge and, also, thus generated negative ions are closer to their natural states.

Similar to the upper second guide member 156 and the upper first guide member 152, the cleaning water 102 discharged from the water spray unit 140 is guided to a central portion of the upper first guide member 152 by the upper second guide member 156. Thereafter, the cleaning water 102 is temporarily collected at the central portion of the upper first guide member 152 and is dispersed again toward the inner wall of the housing 100 by the rotation of the upper first guide member 152.

These water dispersing operation is repeated by using the lower second guide member 158 and the lower first guide member 154.

Therefore, since the exterior air supplied from the blower unit 120 is made to contact the cleaning water 102 which is dispersed multiple times, noxious substances in the air are adsorbed by the cleaning water 102 to discharge out purified fresh air into the indoor space.

In accordance with the preferred embodiment of the present invention as described above, only with the power of the driving unit for rotating the blower, it is possible to rotate the blower and to pump up the cleaning water along the guide unit at the same time. Accordingly, an additional pump is not necessary, which leads to a cost reduction.

Further, since the air sent downward into the air cleaner is made to contact the cleaning water multiple times, contaminants and moisture in the air are adsorbed by the water, and thus only purified clean air can be discharged outside. As such, by dispersing the water multiply times, air purifying efficiency can be greatly improved, and, also, the generation of negative ions can be increased.

As described above, in accordance with the wet type air cleaner capable of generating the negative ions, contaminated air particles are sent downward, whereas the dispersed water is moved upward by the fist guide members. As a result, the contact area between the cleaning water and the air can be increased. Further, by stirring the cleaning water and the air by the rotational operation of the air cleaner and, also, by performing the dispersion of the water by the centrifugal force multiple times through the guide unit, the contact area between the water particles and the air can be further increased. Accordingly, a negative ion generating effect as well as an air purifying efficiency can be maximized.

Moreover, by operating a pumping function and the blower by means of a single driving unit, it is possible to cut component costs and shorten a manufacturing process.

Due to the aforementioned effects, the air purifying efficiency of the air cleaner can be improved and the product size can be minimized. Accordingly, it is possible to diversify the option for the place to install the air cleaner, thus improving user convenience.

While the invention has been shown and described with respect to the preferred embodiments, it will be understood by those skilled in the art that various changes and modification may be made without departing from the scope of the invention as defined in the following claims.

What is claimed is:

1. A wet type air comprising:
a housing containing a water in a bottom thereof;
a blower unit installed in an upper portion of the housing and having a blower for generating a suction air flow to send air to the water, the blower being driven by a single driving source;
a water spray unit for drawing up and dispersing the water; and
a guide unit located between the water spray unit and the water, for guiding the water from the water spray unit to redisperse the water,
wherein the blowing operation of the blower unit and the water intake of the water spray unit are achieved by the single driving source.

2. The air cleaner of claim 1, wherein the water spray unit includes a water intake unit for drawing up the water and one or more spray nozzles for spraying the water.

3. The air cleaner of claim 1, wherein the water intake unit being formed of a funnel-shaped pipe whose cross section is narrowed from top to bottom.

4. The air cleaner of claim 2, wherein the water intake unit has a lower end portion submerged in the water, an upper end portion provided with the spray nozzles and a middle portion located between the lower end portion and the upper end portion, the middle portion and the upper end portion being formed so that their diameters become greater as moving upward to facilitate the water intake.

5. The air cleaner of claim 3, wherein the guide unit is located between the water spray unit and the water.

6. The air cleaner of claim 5, wherein the guide unit has one or more first guide members installed at the water spray unit and a same number of second guide members provided at the housing as that of the first guide members.

7. The air cleaner of claim 5, wherein the first guide members are outwardly, upwardly extended from a lateral surface of the middle portion of the water intake unit by a predetermined distance to have a ring shape and the second guide members are inwardly, downwardly extended from an inner wall of the housing by a preset distance to form opening, the water from the spray unit flowing to the first guide members through the openings.

8. The air cleaner of claim 7, wherein the openings have a diameter equal to or smaller than a maximum diameter of the first guide members.

9. The air cleaner of claim 6, wherein the first and the second guide members are arranged alternately.
